(19) United States
(12) Patent Application Publication
(10) Pub. No.: US 2026/0276919 A1
(43) Pub. Date: Sep. 17, 2026

(54) Semiconductor Device and Method of Making a Solder Wall for Photonics Protection

(71) Applicant: STATS ChipPAC Pte. Ltd., Singapore (SG)

(72) Inventors: Yi Xiang Jasper Tay, Singapore (SG); Swain Hong Alfred Yeo, Singapore (SG); Chee Meng Law, Johor Bahru (MY); Junyi Zeng, Singapore (SG)

(73) Assignee: STATS ChipPAC Pte. Ltd., Singapore (SG)

(21) Appl. No.: 19/079,255

(22) Filed: Mar. 13, 2025

(51) Int. Cl. G02B 6/42

(52) U.S. Cl. CPC G02B 6/4248; G02B 6/4249

(57) ABSTRACT

A semiconductor device has a build-up interconnect structure with an opening formed through the build-up interconnect structure. A semiconductor die includes a photonic circuit. A solder wall is formed on the semiconductor die around the photonic circuit. The semiconductor die is disposed over the build-up interconnect structure with the photonic circuit aligned to the opening. An underfill or encapsulant is disposed between the build-up interconnect structure and semiconductor die.

### FIELD OF THE INVENTION

The present invention relates in general to semiconductor devices and, more particularly, to semiconductor devices and methods of making a solder wall for photonics protection.

### BACKGROUND OF THE INVENTION

Semiconductor devices are commonly found in modern electronic products. Semiconductor devices perform a wide range of functions such as signal processing, high-speed calculations, transmitting and receiving electromagnetic signals, controlling electronic devices, transforming sunlight to electricity, and creating visual images for television displays. Semiconductor devices are found in the fields of communications, power conversion, networks, computers, entertainment, and consumer products. Semiconductor devices are also found in military applications, aviation, automotive, industrial controllers, and office equipment.

Photonic semiconductor devices, which are capable of transmitting or receiving signals via light, are becoming more and more common. Photonic semiconductor die are packaged with an optical window or grating area to allow optical signals in and out. When the package is molded or encapsulated, the encapsulation materials, such as molding compound, underfill, or mold underfill, can flow over the optical window or grating area, which can block the photonic circuit from properly sending or receiving optical signals. Therefore, a need exists for improved methods of keeping encapsulation materials from a grating surface or optical window of a photonic semiconductor die.

### BRIEF DESCRIPTION OF THE DRAWINGS

FIGS. 1a-1h illustrate preparation of a semiconductor wafer with a plurality of photonic semiconductor die separated by a saw street;

FIGS. 2a-2l illustrate forming a semiconductor package with the photonic semiconductor die having a solder wall; and

FIGS. 3a-3c illustrate an electronic device with the semiconductor package.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings. The features shown in the figures are not necessarily drawn to scale. Elements assigned the same reference number in the figures have a similar function to each other. The term “semiconductor die” as used herein refers to both the singular and plural form of the words, and accordingly, can refer to both a single semiconductor device and multiple semiconductor devices.

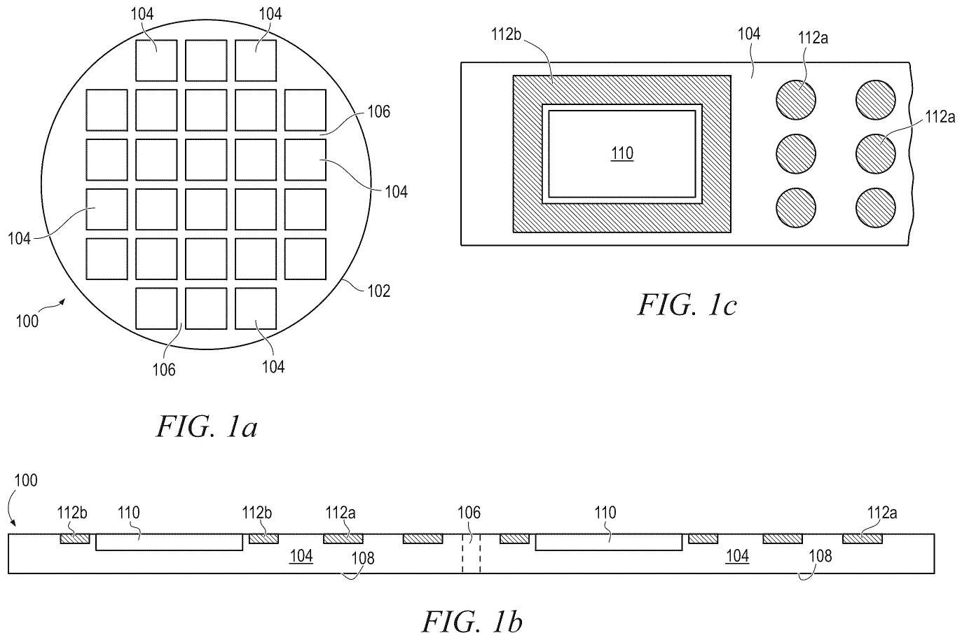

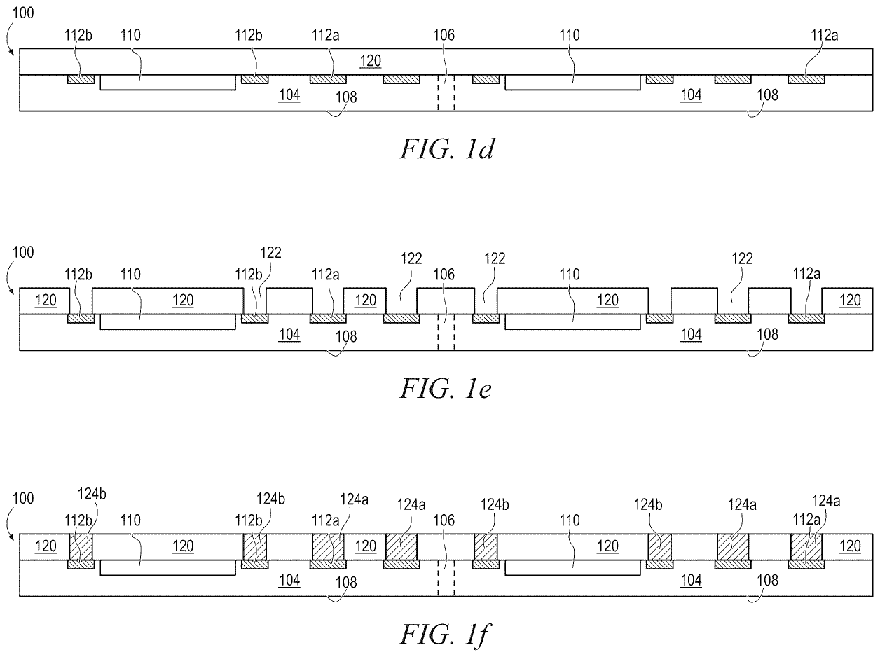

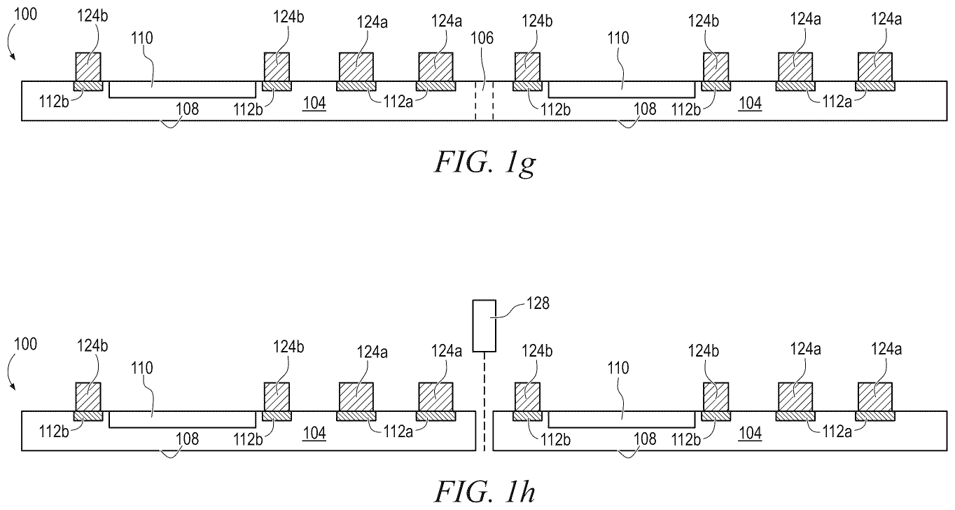

FIG. 1a shows a semiconductor wafer 100 with a base substrate material 102, such as silicon, germanium, aluminum phosphide, aluminum arsenide, gallium arsenide, gallium nitride, indium phosphide, silicon carbide, or other bulk material for structural support. A plurality of photonic semiconductor die 104 is formed on wafer 100 separated by a non-active, inter-die wafer area or saw street 106. Saw street 106 provides cutting areas to singulate semiconductor wafer 100 into individual photonic semiconductor die 104. In one embodiment, semiconductor wafer 100 has a width or diameter of 100-450 millimeters (mm). Wafer 100 can include hundreds or thousands of photonic semiconductor die 104. In some embodiments, photonic semiconductor die 104 is a photonic integrated circuit (PIC), photodetector, or a vertical-external-cavity surface-emitting-laser (VESCEL) component. Other types of photonic semiconductor die are used in other embodiments.

FIG. 1b shows a cross-sectional view of a portion of semiconductor wafer 100. Each photonic semiconductor die 104 has a back or non-active surface 108 and an active surface including a photonic circuit 110 formed within the die. Photonic circuit 110 is an electronic circuit capable of receiving an optical signal and converting the optical signal into an electrical signal for further processing, generating an optical signal based on a received electrical signal, or both. The area of, on, or over photonic circuit 110 may be referred to as a grating area because a grating connector is mounted there in some embodiments. The active surface may also include one or more transistors, diodes, and other circuit elements formed within the active surface to implement analog circuits or digital circuits, such as a digital signal processor (DSP), an application specific integrated circuit (ASIC), memory, or other signal processing circuit. Photonic semiconductor die 104 may also contain IPDs, such as inductors, capacitors, and resistors, for RF signal processing.

Wafer 100 is a wafer of photonic semiconductor die 104 as would typically be delivered by a manufacturer of the wafer to a manufacturer of semiconductor packages that will include the photonic semiconductor die. The manufacturer of wafer 100 has formed an interconnect structure over the active surface including conductive layer 112. Conductive layer 112 includes contact pads 112a for external interconnect and a rectangular pattern 112b that surrounds photonic circuit 110 as shown in the plan view of FIG. 1c. Pattern 112b can also be a circle, a polygon with more than four sides, irregularly shaped, or any other suitable shape that completely surrounds photonic circuit 110. In most embodiments, pattern 112b follows the perimeter of photonic circuit 110 and both are rectangles.

In some embodiments, conductive layer 112 also includes conductive traces to fan in or out to contact pads 112a. The interconnect structure formed on, in, or over the active surface of semiconductor die 104 may have one or more layers of conductive traces with insulating layers formed between the layers. The interconnect structure also electrically interconnects photonic circuit 110 and contact pads 112a per the intended functionality of photonic semiconductor die 104.

The conductive layers, including conductive layer 112, are formed over wafer 100 using physical vapor deposition (PVD), chemical vapor deposition (CVD), electrolytic plating, electroless plating, or another suitable metal deposition process. The conductive layers can be one or more layers of aluminum (Al), copper (Cu), tin (Sn), nickel (Ni), gold (Au), silver (Ag), or other suitable electrically conductive material. Any conductive layer mentioned above or below can be formed of the same methods and materials. Contact pads 112a include an under-bump metallization (UBM) in some embodiments.

In FIG. 1d, photoresist layer 120 is formed over semiconductor wafer 100. Photoresist layer 120 can be formed using any of the methods described herein for insulating layers generally and using any suitable photoresist material. In FIG. 1e, photoresist layer 120 is exposed, developed, and etched to form vias 122 over portions of conductive layer 112 where solder is desired. In other embodiments, photoresist layer 120 is formed of any suitable insulating material, and vias 122 are formed by chemical etching, mechanical drilling, laser ablation, or another suitable means.

In FIG. 1f, vias 122 are filled with a solder or solder paste 124. Solder paste 124 can be Al, Sn, Ni, Au, Ag, Pb, Bi, Cu, solder, and combinations thereof, with an optional flux solution. In one embodiment, the bump material for solder paste 124 is a eutectic Sn/Pb, high-lead solder, or lead-free solder. Solder paste 124 can be disposed in vias 122 by stencil printing, screen printing, jetting or needle dispensing, solder paste droplet deposition, electrodeposition, or another suitable means.

Solder paste 124 forms a plurality of conductive pillars that conform to the shapes of conductive layer 112 in the plan view of FIG. 1b. Each contact pad 112a has a circular or other shaped pillar of solder paste 124a formed on the contact pad. Solder paste 124b, also referred to as solder wall 124b, forms a rectangle or other shaped complete circuit around photonic circuit 110. In FIG. 1g, the remaining photoresist layer 120 is removed by chemical stripping, plasma ashing, a hybrid approach combining the first two options, ozone cleaning, or another suitable process leaving solder or solder paste 124 extending up above wafer 100 on conductive layer 112.

In FIG. 1h, semiconductor wafer 100 is singulated through saw street 106 using a saw blade or laser cutting tool 128 into individual photonic semiconductor die 104. The individual photonic semiconductor die 104 can be inspected and electrically tested for identification of known good die (KGD) or known good unit (KGU) after singulation.

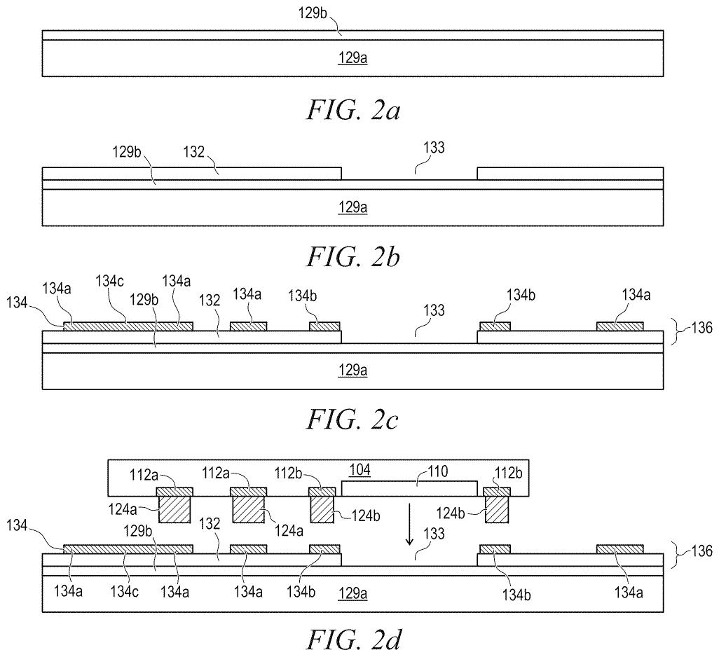

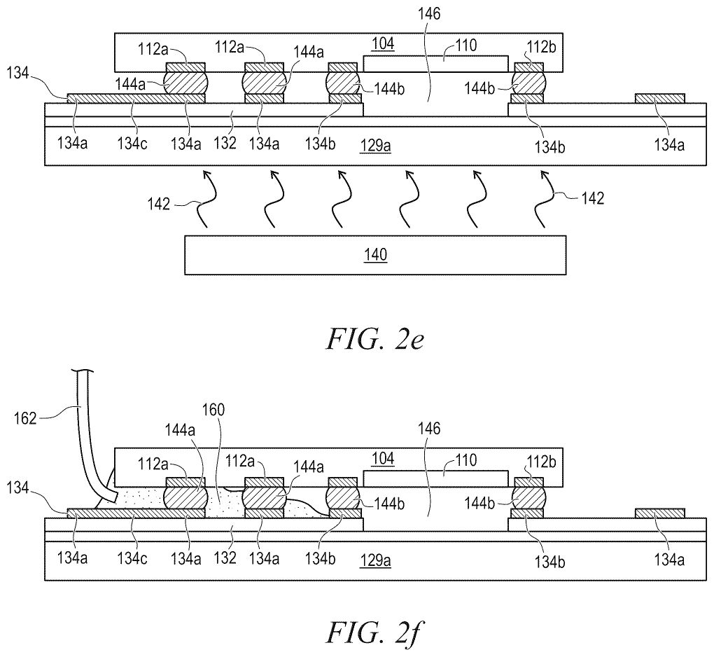

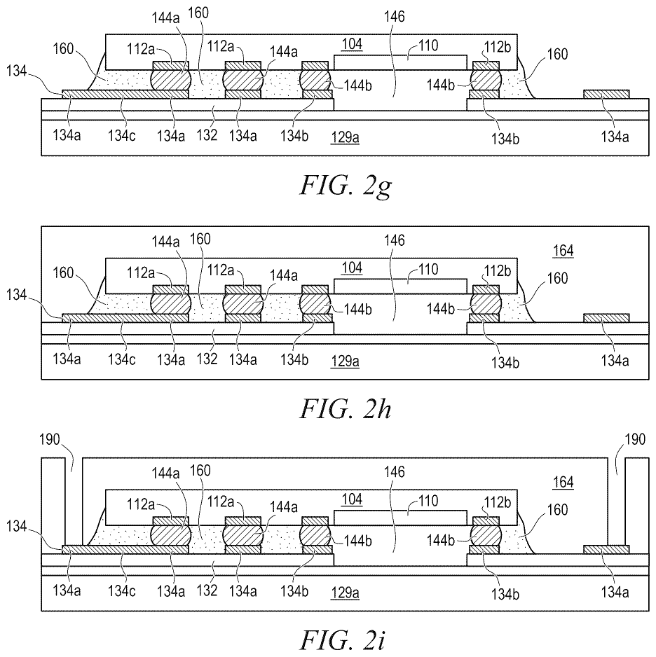

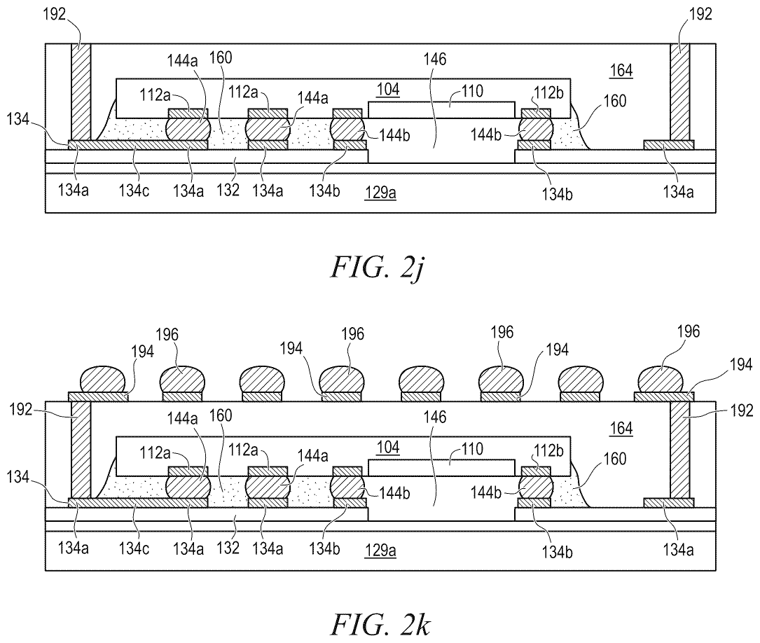

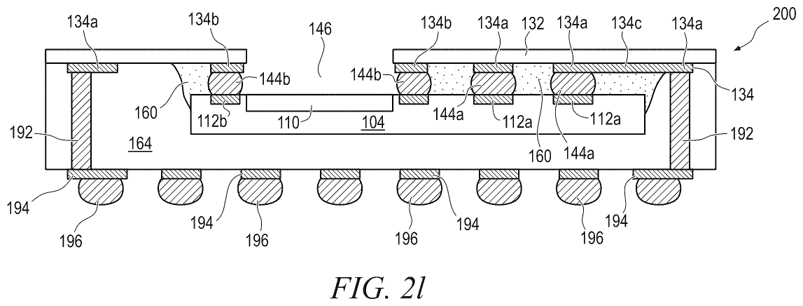

FIGS. 2a-2l illustrate the formation of an optical semiconductor package including a photonic semiconductor die 104. FIG. 2a shows a carrier 129a with an interface layer, debonding adhesive layer, or double-sided tape 129b optionally formed or disposed over carrier 129a as a temporary adhesive bonding film, etch-stop layer, thermal release layer, or UV release layer. Carrier 129a contains sacrificial base material such as silicon, polymer, beryllium oxide, glass, or other suitable low-cost, rigid material for structural support. The combination of carrier 129a and interface layer 129b can be referred to as carrier 129. The term carrier can refer to just carrier 129a or the combination of carrier 129a and interface layer 129b.

In FIG. 2b, an insulating or passivation layer 132 is formed on carrier 129. Insulating layer 132 contains one or more layers of silicon dioxide (SiO2), silicon nitride (Si3N4), silicon oxynitride (SiON), tantalum pentoxide (Ta2O5), aluminum oxide (Al2O3), solder resist, polyimide (PI), photosensitive polyimide (PSPI) benzocyclobutene (BCB), polybenzoxazoles (PBO), and other material having similar insulating and structural properties. Insulating layer 132 can be formed using PVD, CVD, printing, lamination, spin coating, spray coating, sintering, or thermal oxidation. Any insulating, passivation, or dielectric layer mentioned above or below can be formed using any of the materials or methods described for insulating layer 132.

An opening 133 is formed through insulating layer 132 using chemical etching, mechanical drilling, laser ablation, photolithography, or another suitable process. Opening 133 is configured such that when photonic semiconductor die 104 is mounted, photonic circuit 110 will be aligned to the opening. Opening 133 will then allow light signals to pass through insulating layer 132 to photonic circuit 110. Additional openings can be formed through insulating layer 132 if needed for subsequent electrical interconnect to the external surface of the final package being formed.

A conductive layer 134 is formed over insulating layer 132 in FIG. 2c. Conductive layer 134 includes contact pads 134a, a rectangular pattern 134b, and conductive traces 134c fanning in or out from the contact pads. Contact pads 134a can be formed for mounting of semiconductor die 104, or for subsequent electrical interconnect. Rectangular pattern 134b corresponds to rectangular pattern 112b on semiconductor die 104. Optionally, conductive layer 134 can include conductive vias extending through insulating layer 132 for subsequent vertical electrical interconnect. In other embodiments, conductive layer 134 is formed on insulating layer 132 without openings in the insulating layer and openings are formed later to expose contact pads of conductive layer 134 for electrical interconnect.

Insulating layer 132 and conductive layer 134 constitute a build-up interconnect structure 136, so called because the interconnect structure is formed by successively building up insulating layers and conductive layers over carrier 129 until the desired signal routing is achieved. While only one conductive layer and one insulating layer are shown, any number of conductive and insulating layers can be interleaved over each other to form build-up interconnect structure 136. The top conductive layer will have rectangular pattern 134b extending continuously and completely around opening 133.

Rectangular pattern 134b corresponds to and is shaped similarly to rectangular pattern 112b on semiconductor die 104. Opening 133 corresponds to and is shaped similarly to photonic region 110 of semiconductor die 104. In some embodiments, opening 133 is formed after build-up interconnect structure 136 is completed. In other embodiments, opening 133 is cleared of material after each constituent insulating layer and conductive layer of build-up interconnect structure 136 is formed.

In FIG. 2d, a photonic semiconductor die 104 is picked and placed over build-up interconnect structure 136. Each portion of solder paste 124 is aligned to a corresponding portion of conductive layer 134. Solder pillars 124a are aligned to contact pads 134a. The solder paste rectangular pattern 124b is aligned to the conductive layer rectangular pattern 134b. When the photonic semiconductor die is lowered onto build-up interconnect structure 136, each portion of solder paste 124 rests on conductive layer 134. Rectangular patterns 112b, 124b, and 134b all have substantially the same shape in plan view. That shape can be a rectangular outline as illustrated in FIG. 1c or any other suitable shape. In some embodiments, solder paste 124a is disposed onto conductive layer 134 of build-up interconnect structure 136 rather than onto conductive layer 112 of semiconductor die 104.

Conductive layer 112 is electrically and physically coupled to conductive layer 134 by reflowing solder paste 124 in FIG. 2e. Reflow is performed by a heater 140 applying thermal energy 142 to bring solder paste 124 above its melting temperature. Reflow can be performed by laser-assisted bonding or any other suitable means in other embodiments. Reflow of solder paste 124 forms balls or bumps 144a between contact pads 112a and 134a, and a solder wall 144b between rectangular patterns 112b and 134b. Solder wall 144b extends continuously and completely around opening 133 and photonic region 110 and extends completely from semiconductor die 104 to build-up interconnect structure 136, to seal an area 146 over or under photonic region 110. Area 146 is completely surrounded by solder wall 144b.

Solder wall 144b helps balance the overall structure during reflow. Due to photonic region 110 being cantilevered over area 146, that side of semiconductor die 104 can commonly sag during reflow. Solder wall 144b reacts similarly to bumps 144a during the reflow process, keeping the support for semiconductor die 104 balanced. In one embodiment, balanced refers to the total amount of solder paste 124 being equal on two halves of semiconductor die 104. Solder wall 144b can also be considered to balance solder bumps 144a by resulting in the total amount of solder on two halves of semiconductor die 104 being approximately equal. The word balance can also simply mean that solder wall 144b keeps semiconductor die 104 substantially horizontal, or parallel to conductive layer 134, during reflow.

In FIG. 2f, an underfill 160 is deposited between build-up interconnect structure 136 and photonic semiconductor die 104 using a dispenser head or nozzle 162. In capillary underfill dispensing, nozzle 162 is a needle or jetting system used to dispense a precise amount of underfill material along one or more edges of semiconductor die 104. The low viscosity of underfill 160 allows it to flow into the gap between semiconductor die 104 and build-up interconnect structure 136 through capillary action, spreading evenly beneath semiconductor die 104 to encapsulate solder bumps 134a. Other underfill deposition methods are used in other embodiments.

Underfill 160 flows into the space between build-up interconnect structure 136 and photonic semiconductor die 104 to fill the space and provide physical support. Underfill 160 can be a polymer composite material, such as epoxy resin or epoxy acrylate, with or without an added filler. As underfill 160 flows in from the edges of semiconductor die 104, the underfill eventually reaches solder wall 144b. Solder wall 144b forms a seal around area 146, thereby stopping underfill 160 from flowing into the space over or under photonic region 110.

FIG. 2g illustrates underfill 160 after fully dispensing the underfill such that the space between semiconductor die 104 and build-up interconnect structure 136 is completely filled outside of a perimeter formed by solder wall 144b. Underfill 160 may be dispensed along all four edges of semiconductor die 104 to ensure that the underfill reaches all four sides of solder wall 144b. Underfill 160 is then cured, typically by heating in an oven or using another thermal process to solidify the underfill. Blocking underfill 160 using solder wall 144b ensures that the underfill does not extend into opening 133 or over photonic circuit 110.

In FIG. 2h, an encapsulant or molding compound 164 is deposited over and around photonic semiconductor die 104 and build-up interconnect structure 136 using a paste printing, compression molding, transfer molding, liquid encapsulant molding, vacuum lamination, spin coating, or other suitable applicator. Encapsulant 164 can be liquid or granular polymer composite material, such as epoxy resin, epoxy acrylate, or another suitable polymer, with or without a filler. Encapsulant 164 is non-conductive, provides structural support, and environmentally protects the semiconductor device from external elements and contaminants. In some embodiments, underfill 160 is not used, and solder wall 144b still provides the same benefits, mentioned above for the underfill, by blocking encapsulant 164 from flowing over photonic circuit 110. Without underfill 160, FIG. 2h would look the same except that the area of underfill 160 would be occupied by encapsulant 164.

In FIG. 2i openings or vias 190 are formed through encapsulant 164 down to conductive layer 134. Vias 190 are formed by chemical etching, laser etching, mechanical drilling, or another suitable means. Vias 190 expose contact pads 134a for subsequent electrical interconnect. In FIG. 2j, vias 190 are filled with conductive material to form conductive vias 192. Conductive vias 192 are formed by any suitable conductive material deposition means, such as those discussed above for other conductive layers. Conductive vias 192 can be formed of any suitable conductive material, such as those discussed above for conductive layers generally, e.g., copper. Top surfaces of conductive vias 192 are made coplanar to the top surface of encapsulant 164 by backgrinding in some embodiments.

In FIG. 2k, conductive layer 194 and solder bumps 196 are formed on the back surface of encapsulant 164. Conductive layer 194 is formed using methods and materials mentioned above for other conductive layers and is patterned to fan-in electrical connection from conductive vias 192 to solder bumps 196. Bumps 196 are formed on contact pads of conductive layer 194 using the same methods and materials discussed above for solder paste 124.

In other embodiments, an electrically conductive bump material is deposited over contact pads of conductive layer 194 using an evaporation, electrolytic plating, electroless plating, ball drop, or screen printing process. The bump material can be Al, Sn, Ni, Au, Ag, lead (Pb), bismuth (Bi), Cu, solder, and combinations thereof, with an optional flux solution. For example, the bump material can be eutectic Sn/Pb, high-lead solder, or lead-free solder. The bump material is bonded to conductive layer 194 using a suitable attachment or bonding process. In one embodiment, the bump material is reflowed by heating the material above its melting point to form balls or bumps 196. The contact pads of conductive layer 194 on which bumps 196 are formed can be, or include, an under-bump metallization (UBM) having a wetting layer, barrier layer, and adhesion layer. Bumps 196 can also be compression bonded or thermocompression bonded to conductive layer 194.

Bump 196 represents one type of interconnect structure that can be formed over conductive layer 194. The interconnect structure can also use bond wires, conductive paste, stud bump, micro bump, land grid array, or other electrical interconnect. In one embodiment, conductive vias 190, conductive layer 194, and solder bumps 196 are not formed, and the package being formed is mounted to another larger substrate of an end device directly through build-up interconnect structure 136. Build-up interconnect structure 136 can be mounted to a larger PCB using flip-chip mounting with photonic circuit 110 oriented toward the PCB or using bond wires with the photonic circuit oriented away from the PCB.

FIG. 2l illustrates carrier 129 removed by thermal, UV, or other release. A semiconductor package 200 is completed by singulating encapsulant 164 and build-up interconnect structure 136 if necessary to separate a panel of packages from each other. Area 146 remains free of underfill 160 and encapsulant 164 so that photonic circuit 110 is exposed from package 200. In some embodiments, a fiber optic connector is mounted in area 146 as part of the packaging process. In other embodiments, area 146 remains open as illustrated and a fiber optic connector or bare fiber is glued into area 146 as part of the process of installing package 200 into an end device. Alternatively, a lens can be glued into or over area 146 during packaging or later.

Package 200 includes a photonic semiconductor die 104 with a photonic circuit 110 that remains free of interference from underfill 160 or encapsulant 164 thanks to solder wall 144b. Solder wall 144b protects the optical window or grating surface of photonic semiconductor die 104. Solder wall 144b defines a keep-out zone (KOZ) for underfill or encapsulant, extending around opening 146 and photonic circuit 110 to keep encapsulant or underfill from interfering with light transmission. Solder wall 144b provides a physical wall to prevent underfill from contaminating the photonics optical FAU region. Solder wall 144b can be formed using the same materials and during the same processing steps as solder bumps 144a used for electrical interconnect, so no additional material or processing steps are required. Solder wall 144b provides a support structure for photonic integrated circuit (PIC) flip chip mass reflow, acts as a physical dam to block underfill bleeding and contamination, increases process margin for flip chip attachment to reduce cold joints, and provides a clean and neat process with no additional control required for underfill dispensing.

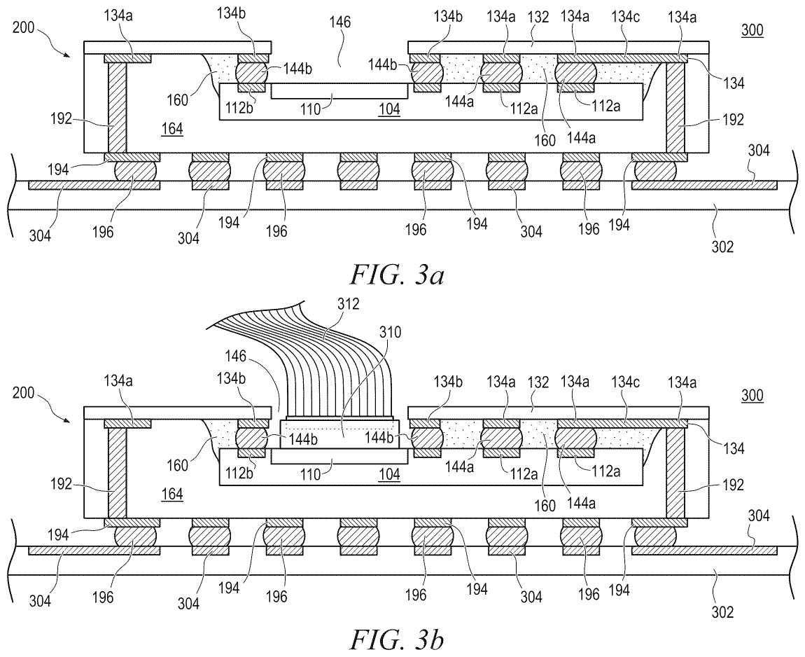

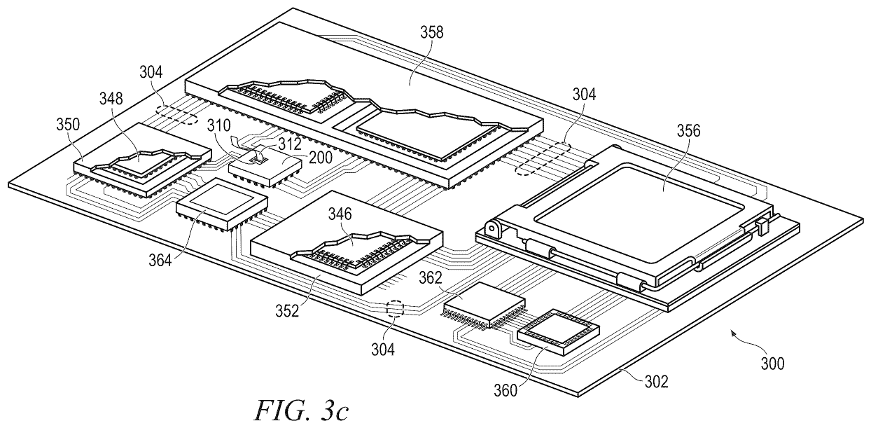

FIGS. 3a-3c illustrate integrating the above-described semiconductor packages, e.g., semiconductor package 200, into a larger electronic device 300. FIG. 3a illustrates a partial cross-section of semiconductor package 200 mounted onto a printed circuit board (PCB) or other substrate 302 as part of electronic device 300. Solder bumps 196 are reflowed onto conductive layer 304 of PCB 302 to physically attach and electrically connect semiconductor package 200 to the PCB. In other embodiments, thermocompression or another suitable attachment and connection methods are used. In some embodiments, an adhesive or underfill layer is used between semiconductor package 200 and PCB 302. Photonic semiconductor die 104 is electrically coupled to conductive layer 304 through bumps 196, conductive layer 194, conductive vias 192, conductive layer 134, and solder bumps 144a.

In FIG. 3b, a fiber array unit (FAU) 310 is mounted onto a grating area of photonic circuit 110. FAU 310 is attached to photonic circuit 110 using a layer of optical adhesive. FAU 310 includes one or more fiber optic cables 312 bundled together for transmitting and receiving optical signals to or from semiconductor die 104. Fiber optic cables 312 can be attached to package 200 using any suitable coupler. In other embodiments, photonic circuit 110 transmits or receives an optical signal without a fiber optic cable being attached.

FIG. 3c illustrates electronic device 300 having a chip carrier substrate or PCB 302 with a plurality of semiconductor packages disposed on a surface of PCB 302, including semiconductor package 200. Electronic device 300 can have one type of semiconductor package, or multiple types of semiconductor packages, depending on the application.

Electronic device 300 can be a stand-alone system that uses the semiconductor packages to perform one or more electrical functions. Alternatively, electronic device 300 can be a subcomponent of a larger system. For example, electronic device 300 can be part of a tablet, cellular phone, digital camera, communication system, or other electronic device. Alternatively, electronic device 300 can be a graphics card, network interface card, or other signal processing card that can be inserted into a computer. The semiconductor package can include microprocessors, memories, ASICs, logic circuits, analog circuits, RF circuits, discrete devices, or other semiconductor die or electrical components. Miniaturization and weight reduction are essential for the products to be accepted by the market. The distance between semiconductor devices may be decreased to achieve higher density. PCB 302 may have a more irregular shape to fit conveniently into more ergonomic and smaller device shells.

In FIG. 3c, PCB 302 provides a general substrate for structural support and electrical interconnect of the semiconductor packages disposed on the PCB. Conductive signal traces 304 are formed over a surface or within layers of PCB 302 using evaporation, electrolytic plating, electroless plating, screen printing, or other suitable metal deposition process. Signal traces 304 provide for electrical communication between each of the semiconductor packages, mounted components, and other external system components. Traces 304 also provide power and ground connections to each of the semiconductor packages.

In some embodiments, a semiconductor device has two packaging levels. First level packaging is a technique for mechanically and electrically attaching the semiconductor die to an intermediate substrate. Second level packaging involves mechanically and electrically attaching the intermediate substrate to the PCB. In other embodiments, a semiconductor device may only have the first level packaging where the die is mechanically and electrically disposed directly on the PCB.

For the purpose of illustration, several types of first level packaging, including bond wire package 346 and flipchip 348, are shown on PCB 302. Additionally, several types of second level packaging, including ball grid array (BGA) 350, bump chip carrier (BCC) 352, land grid array (LGA) 356, multi-chip module (MCM) or SIP module 358, quad flat non-leaded package (QFN) 360, quad flat package 362, and embedded wafer level ball grid array (eWLB) 364 are shown disposed on PCB 302. In one embodiment, eWLB 364 is a fan-out wafer level package (Fo-WLP) or a fan-in wafer level package (Fi-WLP).

Depending upon the system requirements, any combination of semiconductor packages, configured with any combination of first and second level packaging styles, as well as other electrical components, can be connected to PCB 302. In some embodiments, electronic device 300 includes a single attached semiconductor package, while other embodiments call for multiple interconnected packages. By combining one or more semiconductor packages over a single substrate, manufacturers can incorporate pre-made components into electronic devices and systems. Because the semiconductor packages include sophisticated functionality, electronic devices can be manufactured using less expensive components and a streamlined manufacturing process. The resulting devices are less likely to fail and are less expensive to manufacture, which lowers costs up and down the supply chain.

While one or more embodiments of the present invention have been illustrated in detail, the skilled artisan will appreciate that modifications and adaptations to those embodiments may be made without departing from the scope of the present invention as set forth in the following claims.

What is claimed:

1. A method of making a semiconductor device, comprising:
forming a build-up interconnect structure;
forming an opening through the build-up interconnect structure;
providing a semiconductor die including a photonic circuit;
forming a solder wall on the semiconductor die around the photonic circuit;
disposing the semiconductor die over the build-up interconnect structure with the photonic circuit aligned to the opening; and
depositing an underfill or encapsulant between the build-up interconnect structure and semiconductor die.

2. The method of claim 1, further including disposing a solder bump between the semiconductor die and build-up interconnect structure outside a perimeter of the solder wall.

3. The method of claim 2, further including reflowing the solder bump and solder wall, wherein the solder wall supports the semiconductor die during reflow.

4. The method of claim 1, further including mounting a fiber array unit (FAU) onto the photonic circuit.

5. The method of claim 1, further including forming the solder wall to extend continuously and completely around the photonic circuit in plan view.

6. The method of claim 1, further including depositing the underfill or encapsulant to extend to the solder wall, wherein the solder wall blocks the underfill or encapsulant from flowing over the photonic circuit.

7. A method of making a semiconductor device, comprising:
providing a semiconductor die including a photonic circuit;
forming a solder wall on the semiconductor die around the photonic circuit;
forming a first conductive layer;
disposing the semiconductor die over the first conductive layer with the solder wall aligned to a portion of the first conductive layer; and
depositing an underfill or encapsulant over the semiconductor die.

8. The method of claim 7, further including disposing a solder bump between the semiconductor die and first conductive layer outside a perimeter of the solder wall.

9. The method of claim 8, further including reflowing the solder bump and solder wall, wherein the solder wall supports the semiconductor die during reflow.

10. The method of claim 7, further including mounting a fiber array unit (FAU) onto the photonic circuit.

11. The method of claim 7, further including forming the solder wall to extend continuously and completely around the photonic circuit in plan view.

12. The method of claim 7, further including depositing the underfill or encapsulant to extend to the solder wall, wherein the solder wall blocks the underfill or encapsulant from flowing over the photonic circuit.

13. The method of claim 7, further including forming a second conductive layer over the semiconductor die opposite the first conductive layer.

14. A semiconductor device, comprising:
a build-up interconnect structure;
an opening formed through the build-up interconnect structure;
a semiconductor die disposed over the build-up interconnect structure with a photonic circuit of the semiconductor die aligned to the opening;
a solder wall disposed between the semiconductor die and build-up interconnect structure around the photonic circuit; and
an underfill or encapsulant deposited between the build-up interconnect structure and semiconductor die.

15. The semiconductor device of claim 14, further including a solder bump disposed between the semiconductor die and build-up interconnect structure outside a perimeter of the solder wall.

16. The semiconductor device of claim 15, wherein the solder wall balances the solder bump in supporting the semiconductor die.

17. The semiconductor device of claim 14, further including a fiber array unit (FAU) mounted onto the photonic circuit.

18. The semiconductor device of claim 14, wherein the solder wall extends continuously and completely around the photonic circuit in plan view.

19. The semiconductor device of claim 14, wherein the underfill or encapsulant extends to the solder wall.

20. A semiconductor device, comprising:
a semiconductor die including a photonic circuit;
a solder wall formed on the semiconductor die around the photonic circuit;
a first conductive layer formed over the semiconductor die with a portion of the first conductive layer disposed over the solder wall; and
an underfill or encapsulant disposed over the semiconductor die.

21. The semiconductor device of claim 20, further including a solder bump disposed between the semiconductor die and first conductive layer outside a perimeter of the solder wall.

22. The semiconductor device of claim 21, wherein the solder wall balances the solder bump in supporting the semiconductor die.

23. The semiconductor device of claim 20, further including a fiber array unit (FAU) disposed over the photonic circuit.

24. The semiconductor device of claim 20, wherein the solder wall extends continuously and completely around the photonic circuit in plan view.

25. The semiconductor device of claim 20, wherein the underfill or encapsulant extends to the solder wall.
